(19) United States
(12) Patent Application Publication
(10) Pub. No.: US 2024/0411004 A1
(43) Pub. Date: Dec. 12, 2024

(54) SENSING METHOD AND APPARATUS AND COMMUNICATION DEVICE

(71) Applicant: VIVO MOBILE COMMUNICATION CO., LTD., Dongguan (CN)

(72) Inventors: Jian YAO, Dongguan (CN); Dajie JIANG, Dongguan (CN); Baolong CHEN, Dongguan (CN); Pucong WANG, Dongguan (CN)

(73) Assignee: VIVO MOBILE COMMUNICATION CO., LTD., Dongguan (CN)

(21) Appl. No.: 18/811,615

(22) Filed: Aug. 21, 2024

Related U.S. Application Data
(63) Continuation of application No. PCT/CN2023/077396, filed on Feb. 21, 2023.

(30) Foreign Application Priority Data
Feb. 25, 2022 (CN) 202210178898.6

(51) Int. Cl. G01S 13/00; G01S 7/00; G01S 13/86

(52) U.S. Cl. CPC G01S 13/006; G01S 7/006; G01S 13/86

(57) ABSTRACT

A sensing method and a communication device are provided. The sensing method includes: obtaining, by a first device, at least one sensing measurement result based on an eigenvalue of at least one first matrix. The at least one first matrix is obtained based on a time-frequency domain channel matrix. The time-frequency domain channel matrix includes related information of frequency domain channel responses corresponding to a plurality of time-frequency domain sampling points. Each time-frequency domain channel matrix corresponds to one antenna transmit-receive combination. The related information of the frequency domain channel response is obtained by the first device by performing channel estimation on a received first signal. The first matrix is a covariance matrix or a correlation coefficient matrix corresponding to the time-frequency domain channel matrix; and obtaining, by the first device, a target sensing measurement result based on the at least one sensing measurement result.

### CROSS-REFERENCE TO RELATED APPLICATIONS

This application is a continuation of International Application No. PCT/CN2023/077396, filed on Feb. 21, 2023, which claims priority to Chinese Patent Application No. 202210178898.6, filed on Feb. 25, 2022. The entire contents of each of the above-referenced applications are expressly incorporated herein by reference.

### TECHNICAL FIELD

This application relates to the field of communication technologies, and in particular, to a sensing method and apparatus and a communication device.

### BACKGROUND

A future mobile communication system has a sensing capability in addition to a communication capability. A sensing capability is that one or more devices with the sensing capability can sense information such as a direction, a distance, and a speed of a target object by sending and receiving a wireless signal, or detect, trace, identify, and image a target object, an event, an environment, or the like. Currently, there are many types of sensing functions, but there is no explicit solution to implement sensing functions in scenarios such as intrusion detection and track tracing.

### SUMMARY

Embodiments of this application provide a sensing method and apparatus and a communication device.

According to a first aspect, a sensing method is provided, including:
obtaining, by a first device, at least one sensing measurement result based on an eigenvalue of at least one first matrix, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel response is obtained by the first device by performing channel estimation on a received first signal, and the first matrix is a covariance matrix or a correlation coefficient matrix corresponding to the time-frequency domain channel matrix; and obtaining, by the first device, a target sensing measurement result based on the at least one sensing measurement result.

According to a second aspect, a sensing method is provided, including:
obtaining, by a second device, a target sensing measurement result; where
the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal.

According to a third aspect, a sensing apparatus is provided, including:
a first obtaining module, configured to obtain at least one sensing measurement result based on an eigenvalue of at least one first matrix, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel response is obtained by a first device by performing channel estimation on a received first signal, and the first matrix is a covariance matrix or a correlation coefficient matrix corresponding to the time-frequency domain channel matrix; and a second obtaining module, configured to obtain a target sensing measurement result based on the at least one sensing measurement result.

According to a fourth aspect, a sensing apparatus is provided, including:
a third obtaining module, configured to obtain a target sensing measurement result; where
the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal.

According to a fifth aspect, a communication device is provided. The communication device includes a processor and a memory, the memory stores a program or an instruction that can run on the processor, and when the program or the instruction is executed by the processor, steps of the sensing method according to the first aspect or the second aspect are implemented.

According to a sixth aspect, a first device is provided, including a processor and a communication interface, where the processor is configured to: obtain at least one sensing measurement result based on an eigenvalue of at least one first matrix, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel response is obtained by a first device by performing channel estimation on a received first signal, and the first matrix is a covariance matrix or a correlation coefficient matrix corresponding to the time-frequency domain channel matrix; and obtain a target sensing measurement result based on the at least one sensing measurement result.

According to a seventh aspect, a second device is provided, including a processor and a communication interface, where the communication interface is configured to obtain a target sensing measurement result; where the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal.

According to an eighth aspect, a sensing system is provided, including a first device and a second device, where the first device may be configured to perform steps of the sensing method according to the first aspect, and the second device may be configured to perform steps of the sensing method according to the second aspect.

According to a ninth aspect, a readable storage medium is provided, where the readable storage medium stores a program or an instruction, and when the program or the instruction is executed by a processor, steps of the method according to the first aspect or steps of the method according to the second aspect are implemented.

According to a tenth aspect, a chip is provided. The chip includes a processor and a communication interface, the communication interface is coupled to the processor, and the processor is configured to run a program or an instruction to implement the method according to the first aspect or the second aspect.

According to an eleventh aspect, a computer program or a computer program product is provided, where the computer program or the computer program product is stored in a storage medium, and the computer program or the computer program product is executed by at least one processor to implement steps of the sensing method according to the first aspect or the second aspect.

In the embodiments of this application, the first device performs channel estimation processing on the received first signal to obtain at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and obtains a target sensing measurement result based on an eigenvalue obtained through decomposition, so that information such as a location and a speed of a target object in a target environment can be obtained based on the target sensing measurement result, thereby implementing a wireless sensing function in a scenario such as intrusion detection or track tracing.

### BRIEF DESCRIPTION OF DRAWINGS

FIG. 1 is a diagram of a structure of a communication system to which embodiments of this application can be applied;

FIG. 2 is a first schematic flowchart of a sensing method according to an embodiment of this application;

FIG. 3 is a schematic diagram of a time domain calculation window according to an embodiment of this application;

FIG. 4 is a second schematic flowchart of a sensing method according to an embodiment of this application;

FIG. 5 is a first schematic diagram of modules of a sensing apparatus according to an embodiment of this application;

FIG. 6 is a second schematic diagram of modules of a sensing apparatus according to an embodiment of this application;

FIG. 7 is a structural block diagram of a communication device according to an embodiment of this application;

FIG. 8 is a structural block diagram of a terminal according to an embodiment of this application;

FIG. 9 is a first structural block diagram of a network side device according to an embodiment of this application; and

FIG. 10 is a second structural block diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Time Evolution (LTE) or LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may often be used interchangeably. The described technologies can be applied to the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

FIG. 1 is a block diagram of a wireless communication system to which the embodiments of this application may be applied. The wireless communication system includes a terminal 11 and a network side device 12. The terminal 11 may be a terminal side device such as a mobile phone, a Tablet Personal Computer (TPC), a Laptop Computer (LC) that is alternatively referred to as a notebook computer, a Personal Digital Assistant (PDA), a palmtop computer, a netbook, an Ultra-mobile Personal Computer (UMPC), a Mobile Internet Device (MID), an Augmented Reality (AR) or Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Networks (WLAN) access point, a Wireless Fidelity (WiFi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art, provided that the same technical effects are achieved. The base station is not limited to a specific technical vocabulary. It should be noted that in the embodiments of this application, a base station in an NR system is merely used as an example for description, but does not limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

To enable a person skilled in the art to better understand the embodiments of this application, the following descriptions are provided first.

Integrated sensing and communication means that a design of integrated communication and sensing functions is implemented through spectrum sharing and hardware sharing in a same system. While information is transmitted, the system can sense information such as a direction, a distance, and a speed, and detect, trace, and identify a target object or an event. A communication system and a sensing system are complementary to each other, to improve overall performance and bring better service experience.

A future mobile communication system such as a B5G system or a 6G system has a sensing ability in addition to a communication capability. The sensing capability is that one or more devices with the sensing capability can sense information such as a direction, a distance, and a speed of a target object by sending and receiving a wireless signal, or detect, trace, identify, and image a target object, an event, an environment, or the like. In the future, with the deployment of a small base station with a capability of a high frequency band and high bandwidth such as millimeter wave and terahertz in a 6G network, sensing resolution is significantly improved when compared with a centimeter wave, so that the 6G network can provide a more precise sensing service.

Integration of communication and radar is a typical application of fused communication and sensing. In the past, a radar system and a communication system were strictly differentiated due to different research objects and concerns. In most scenarios, the two systems are studied separately. In fact, the radar system and the communication system are both used as a typical manner of information sending, obtaining, processing, and exchanging, and have many similarities in terms of a working principle, a system architecture, and a frequency band. A design of integrated communication and radar is quite feasible, which is mainly embodied in the following aspects: First, both the communication system and the sensing system are based on the electromagnetic wave theory, and transmission and reception of an electromagnetic wave are used to complete information obtaining and transmission. Second, both the communication system and the sensing system have structures such as an antenna, a transmit end, a receive end, a signal processor, and the like, and overlap to a large extent in terms of hardware resources. With the development of technologies, there is increasingly more overlapping between the two in terms of working frequency bands. In addition, there are similarities in terms of key technologies such as signal modulation and reception detection and waveform design. Fusion of the communication system and the radar system can bring many advantages, such as reducing costs, reducing sizes, reducing power consumption, improving spectrum efficiency, and reducing mutual interference, thereby improving overall system performance.

Currently, there are much related research on the integrated design of the radar system and the communication system. A typical joint design includes: spectrum coexistence, that is, the two systems work independently, and information exchange can be allowed to reduce mutual interference; sharing of a receive end, where in this case, transmit ends of the two systems send respective signal waveforms, and the waveforms of the two systems need to be orthogonal, thus not affecting respective receiving and detection; sharing of a transmit end, that is, the transmit end transmits a joint waveform of a radar and communication; and sharing of a transmit end and a receive end, that is, resources are shared on a transmit end and a receive end of the two systems, and similarly, a joint waveform or waveforms in an orthogonal relationship need to be used.

During sensing, sensing may be performed based on a single-station mode, that is, transmit-receive co-location: a transmit end transmits a signal used for sensing, and then receives an echo signal and analyzes the echo signal, and extracts a sensing parameter. For example, a base station serves as a transmit end and a receive end of the signal used for sensing, and a terminal or another object serves as a sensing target. For example, sensing may be performed based on a dual-station or multi-station mode, that is, receive-receive non-co-location: a transmit end transmits a signal used for sensing, and another receive end receives and analyzes the signal, and extracts a sensing parameter. For example, a base station 1 serves as a transmit end of the signal used for sensing, and a terminal or a base station 2 serves as a receive end of the signal used for sensing. Similarly, the transmit end for sensing in the single-station or multi-station mode may also be a terminal.

In the communication system, a modulation symbol that carries information and a pilot symbol that is used for channel estimation need to be jointly sent, and decoding performance is focused on. In a channel estimation algorithm of the communication system, only a composite channel with limited unknown parameters needs to be estimated, and optimization objectives are generally to improve a throughput and transmission reliability. Concerned performance indicators are generally spectrum efficiency, a channel capacity, a Signal to Noise Ratio (SNR), a Signal to Interference plus Noise Ratio (SINR), a Bit Error Rate (BER), a Block Error Rate (BLER), and a Symbol Error Rate (SER). However, in the sensing system, an information bearer problem does not need to be considered in a signal sending process. Generally, an optimized or unmodulated transmit signal is used, and a change caused by a sensing target to the transmit signal, that is, a response characteristic, is focused on. Generally, an optimization objective is to improve parameter estimation precision. Performance measurement indicators may be a fuzzy function, a Cramer-Rao lower bound, a root mean square error, mutual information, a rate distortion function, a radar estimation rate, a Welch lower bound, and some indicators associated with a sensing scenario and a requirement.

Currently, in many studies, a sensing function has been implemented by using the communication system, and there are many types of sensing services. However, there is no explicit solution for how to implement the sensing function in an intrusion detection scenario.

With reference to the accompanying drawings, a sensing method provided in the embodiments of this application is described in detail below by using specific embodiments and application scenarios thereof.

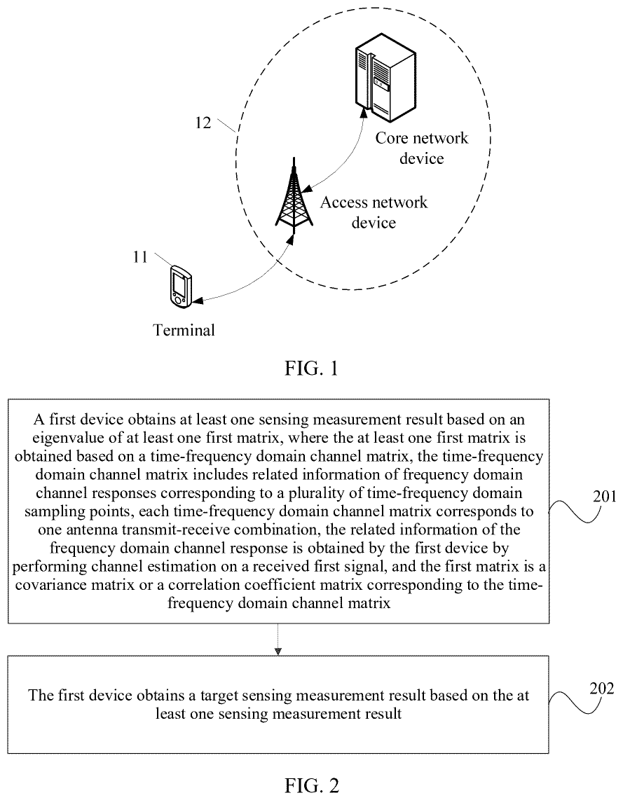

As shown in FIG. 2, an embodiment of this application provides a sensing method, including the following steps.

Step 201: A first device obtains at least one sensing measurement result based on an eigenvalue of at least one first matrix, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel response is obtained by the first device by performing channel estimation on a received first signal, and the first matrix is a covariance matrix or a correlation coefficient matrix corresponding to the time-frequency domain channel matrix.

In this embodiment of this application, the first device performs channel estimation processing on the received first signal to obtain the at least one time-frequency domain channel matrix, obtains the at least one first matrix based on the at least one time-frequency domain channel matrix, and obtains the foregoing sensing measurement result based on the eigenvalue of the first matrix.

The first signal may be a sensing signal, or may be a communication signal, and the communication signal can be used for sensing. For example, the first signal may be a signal used to obtain information such as a direction, a distance, and a speed of a target object, or a signal used to detect, trace, identify, and image a target object, an event, or an environment.

A dimension of the foregoing time-frequency domain channel matrix is M*N or N*M, where M represents the quantity of subcarriers (or the quantity of frequency domain sampling points), and N represents the quantity of time domain sampling points. Both M and N are positive integers.

One antenna transmit-receive combination may correspond to at least one time-frequency domain channel matrix. Each first matrix corresponds to one time-frequency domain channel matrix.

Step 202: The first device obtains a target sensing measurement result based on the at least one sensing measurement result.

Based on the target sensing measurement result, the first device can obtain information such as a location and a speed of a target object in a target environment.

In this embodiment of this application, the first device performs channel estimation processing on the received first signal to obtain the at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and obtains a target sensing measurement result based on an eigenvalue obtained through decomposition, so that information such as a location and a speed of the target object in the target environment can be obtained based on the target sensing measurement result, thereby implementing a wireless sensing function in a scenario such as intrusion detection or track tracing.

In some embodiments, the first matrix includes at least one of the following:
a frequency domain covariance matrix corresponding to the time-frequency domain channel matrix;
a frequency domain correlation coefficient matrix corresponding to the time-frequency domain channel matrix;
a time domain covariance matrix corresponding to the time-frequency domain channel matrix; and
a time domain correlation coefficient matrix corresponding to the time-frequency domain channel matrix.

In some embodiments, that the first device obtains the at least one sensing measurement result based on the eigenvalue of the at least one first matrix includes:
obtaining the at least one sensing measurement result based on at least one of a maximum eigenvalue, all eigenvalues, and a target eigenvalue of the first matrix, where the target eigenvalue is a largest eigenvalue among all the eigenvalues of the first matrix excluding the maximum eigenvalue.

In some embodiments, the obtaining the at least one sensing measurement result based on at least one of the maximum eigenvalue, all the eigenvalues, and the target eigenvalue of the first matrix includes:
obtaining the at least one sensing measurement result based on a weighted combined value of the maximum eigenvalue and the target eigenvalue of the first matrix; or
obtaining the at least one sensing measurement result based on a ratio between the maximum eigenvalue of the first matrix and a sum of all the eigenvalues of the first matrix; or
obtaining the at least one sensing measurement result based on a ratio between a weighted combined value of the maximum eigenvalue and the target eigenvalue of the first matrix and a sum of all the eigenvalues; or
obtaining the at least one sensing measurement result based on a value obtained after a preset threshold is subtracted from a ratio between a sum of all the eigenvalues of the first matrix and the maximum eigenvalue. Herein, the preset threshold is set, so that a value of the sensing measurement result is limited to a preset range.

It should be noted that a ratio between A and B in this embodiment of this application includes A to B or B to A.

In some embodiments, an element in each time-frequency domain channel matrix includes one of the following:
an original complex value of a frequency domain channel response corresponding to the antenna transmit-receive combination;
an amplitude of a frequency domain channel response corresponding to the antenna transmit-receive combination;
a phase of a frequency domain channel response corresponding to the antenna transmit-receive combination;
at least one of I-channel data and Q-channel data of a frequency domain channel response corresponding to the antenna transmit-receive combination;
a weighted combined value of an amplitude and a phase of a frequency domain channel response corresponding to the antenna transmit-receive combination;
a weighted combined value of I-channel data and Q-channel data of a frequency domain channel response corresponding to the antenna transmit-receive combination;
an original complex value of a first result, where the first result is a quotient or a conjugate multiplication result of frequency domain channel responses corresponding to a first antenna transmit-receive combination and a second antenna transmit-receive combination;
an amplitude of the first result;
a phase of the first result;
at least one of I-channel data and Q-channel data of the first result;
a weighted combined value of the amplitude and the phase of the first result; and
a weighted combined value of the I-channel data and the Q-channel data of the first result.

In this embodiment of this application, one antenna transmit-receive combination may correspond to at least one time-frequency domain channel matrix. For example, a first antenna combination corresponds to a first time-frequency domain channel matrix, where a type of an element in the first time-frequency domain channel matrix is an original complex value of a frequency domain channel response; or the first antenna combination corresponds to a second time-frequency domain channel matrix and a third time-frequency domain channel matrix, where a type of an element in the second time-frequency domain channel matrix is an amplitude of a frequency domain channel response, and a type of an element in the third time-frequency domain channel matrix is a phase of a frequency domain channel response. Herein, the amplitude and the phase of the frequency domain channel response are obtained based on an original complex number of the frequency domain channel response.

In addition, in this embodiment of this application, elements in at least two time-frequency domain channel matrices corresponding to a same antenna combination are of different types, and elements in a same time-frequency domain channel matrix are of a same type. Herein, an element type may be an original complex value, an amplitude, or a phase of a frequency domain channel response corresponding to the antenna transmit-receive combination, at least one of I-channel data and Q-channel data, an amplitude or a phase of the first result, or the like.

In some embodiments, that the first device obtains the at least one sensing measurement result based on the eigenvalue of the at least one first matrix includes:
performing weighted combination processing on eigenvalues in at least two first matrices, to obtain the sensing measurement result.

For example, one antenna transmit-receive combination corresponds to at least two time-frequency domain channel matrices, and in this case, one first matrix is obtained based on each time-frequency domain channel matrix, and then weighted combination processing is performed on obtained eigenvalues in the at least two first matrices to obtain a sensing measurement result corresponding to the antenna transmit-receive combination.

The weighted combination processing in this embodiment of this application includes summing processing and averaging processing.

In some embodiments, that the first device obtains the target sensing measurement result based on the at least one sensing measurement result includes:
using, by the first device, the at least one sensing measurement results as the target sensing measurement result; or
performing, by the first device, weighted combination processing on at least two sensing measurement results, to obtain the target sensing measurement result.

In some embodiments, that the first device obtains the target sensing measurement result based on the at least one sensing measurement result includes at least one of the following:
selecting a sensing measurement result that meets first threshold information as the target sensing measurement result, for example, using a sensing measurement result that is higher than the first threshold information as the target sensing measurement result, where in an intrusion detection scenario, if the target sensing measurement result meets the first threshold information, it is determined that intrusion exists in the target environment;
using relationship information between the sensing measurement result and the first threshold information as the target sensing measurement result; where the relationship information herein may be used to indicate whether the sensing measurement result is higher than the first threshold information, for example, if the sensing measurement result is higher than the first threshold information, “1” is reported, or otherwise, “0” is reported; and in this case, corresponding to the intrusion detection scenario, if “1” is reported, it indicates that intrusion exists, and if “0” is reported, it indicates that no intrusion exists;
in a case that the sensing measurement result meets the first threshold information, using a difference between the sensing measurement result and the first threshold information as the target sensing measurement result; or
in a case that the sensing measurement result meets the first threshold information, using target information obtained based on the time-frequency domain channel matrix as the target sensing measurement result (that is, when it is determined that intrusion exists, a sensing measurement result required to trace an intrusion target track is obtained by reporting the target information); where
the target information includes at least one of the following:
Doppler information of a target object;
a speed of the target object;
coordinates (location) of the target object;
a distance between the target object and a signal transmitting-receiving device;
an angle between the target object and the signal transmitting-receiving device; and
delay information of the first signal from being transmitted to being received.

In some embodiments, the method in this embodiment of this application further includes:
reporting, by the first device, the target sensing measurement result or a quantization result of the target sensing measurement result to a second device.

In this embodiment of this application, each antenna combination corresponds to one sensing measurement result. In a case that there are a plurality of antenna transmit-receive combinations, a plurality of sensing measurement results may be obtained. The first device may report the at least one sensing measurement result to the second device, for example, select a maximum value or a minimum value to report the at least one sensing measurement result; or perform weighted combination processing on a plurality of sensing measurement results, and then report a value obtained after the combination processing (that is, the target sensing measurement result) to the second device.

In addition, the sensing measurement result that meets the first threshold information is selected for reporting, and/or the relationship information between the sensing measurement result and the first threshold information is reported, so that reporting bits can be effectively reduced. Moreover, in a case that the sensing measurement result meets the first threshold information, the difference between the sensing measurement result and the first threshold information and/or the target sensing measurement result are/is reported to the second device, so that it is convenient for the second device to adjust first indication information subsequently.

Herein, the first device reports the target sensing measurement result obtained based on the at least one sensing measurement result to the second device, so that the second device can obtain information such as a location and a speed of the target object in the target environment based on the target sensing measurement result.

In some embodiments, the target sensing measurement result further includes:
time at which the first device receives the first signal;
time at which the first device obtains the sensing measurement result or time at which the first device obtains the target sensing measurement result; and
time unit information corresponding to the first signal.

Herein, the foregoing time unit information includes at least one of a frame number, a half-frame number, a slot number, and a symbol sequence number.

In some embodiments, before the first device obtains the at least one sensing measurement result based on the eigenvalue of the at least one first matrix, the method further includes:
receiving first indication information, where the first indication information is used to indicate at least one of the following:
sensing requirement information, where the sensing requirement information corresponds to at least one of a sensing measurement quantity, the first threshold information, configuration information of the first signal, and related information of the time-frequency domain channel matrix, and herein, the at least one of the sensing measurement quantity, the first threshold information, the configuration information of the first signal, and the related information of the time-frequency domain channel matrix can be indirectly obtained by using the sensing requirement information;
a sensing measurement quantity, where the sensing measurement quantity corresponds to the sensing measurement result, and the sensing measurement quantity is used to indicate the first device to obtain, through calculation based on the first signal, a sensing measurement result corresponding to the sensing measurement quantity;
the first threshold information;
configuration information of the first signal; and
related information of the time-frequency domain channel matrix, where the related information of the time-frequency domain channel matrix is associated with the configuration information of the first signal.

In this embodiment of this application, the sensing requirement information includes at least one of the following:
a sensing service type, for example, intrusion detection, track tracing, environment reconstruction, respiration detection, or action identification;
a sensing area, for example, geographic coordinates of the sensing area, a length, a width, a height, a distance, an angle range, and the like of the sensing area;
a sensing target type, for example, a car, a motorcycle, or a pedestrian, which indirectly indicates a moving speed range of a sensing target and a reflection power level for a radio signal;
Quality of Service (QoS) of sensing or integrated sensing and communication, for example, a priority of a sensing or integrated sensing and communication service, a requirement for sensing resolution, a requirement for sensing precision or a sensing error, a sensing delay budget, a requirement for a maximum sensing range, a requirement for a continuous sensing capability, a requirement for a sensing update frequency, a detection probability, a false alarm probability, and a requirement for a miss detection probability;
communication QoS (for an integrated sensing and communication service), for example, a communication delay budget or a false alarm rate;
the quantity of sensing targets in the sensing area; and
density of sensing targets in the sensing area.

In some embodiments, the related information of the time-frequency domain matrix includes at least one of the following:
time domain calculation window information, including the quantity of time domain sampling points, a time domain sampling interval, or a time domain sampling location, or a size of a time domain calculation window corresponding to a time-frequency domain channel matrix H, and a start time or a cut-off time of the time domain calculation window corresponding to H; frequency domain calculation window information, including the quantity of
frequency domain sampling points (the quantity of subcarriers), a frequency domain sampling interval, or a frequency domain sampling location;
a sliding step of a time domain calculation window of the time-frequency domain channel matrix, where the sliding step is used to indicate a start time and/or a cut-off time of a time domain calculation window of a time-frequency domain channel matrix for next calculation; and
element type indication information of the time-frequency domain channel matrix, such as an original complex number value type, an amplitude type, or a phase type.

In some embodiments, after the first device reports the target sensing measurement result or the quantization result of the target sensing measurement result to the second device, the method further includes:
receiving second indication information, where the second indication information is sent in a case that the target sensing measurement result meets the first threshold information, and the second indication information is used to adjust a target parameter in the first indication information.

In some embodiments, the target parameter includes at least one of the following:
the sensing requirement information, for example, adding track tracing and related requirement information;
the sensing measurement quantity, for example, adding measurement quantities such as a delay, Doppler, an angle, a speed, a distance, and coordinates (location);
the configuration information of the first signal, for example, increasing time domain density of the first signal; and
the related information of the time-frequency domain channel matrix, for example, increasing the quantity of time domain sampling points.

For example, for an intrusion detection scenario, if intrusion of the target object in the target environment is detected based on the sensing measurement result, the foregoing second indication information may be sent, so that the first device performs corresponding measurement on the target object according to the second indication information, to implement closer tracing and detection.

It should be noted that, in this embodiment of this application, the first device may determine whether the sensing measurement result meets the first threshold information, and report, to the second device, related information of whether the sensing measurement result meets the first threshold information, or the second device may determine, based on the information reported by the first device, whether the sensing measurement result meets the first threshold information. For example, the first device obtains three sensing measurement results based on the time-frequency domain channel matrix, processes the three sensing measurement results based on a preset algorithm to obtain a first sensing measurement result, determines whether the first sensing measurement result meets the first threshold information, and sends, to the second device, indication information used to indicate whether the first sensing measurement result meets the first threshold information. For example, the second device may process the three sensing measurement results based on a preset algorithm to obtain a first sensing measurement result, and determine whether the first sensing measurement result meets the first threshold information.

It should be noted that in this embodiment of this application, the first signal (which may also be referred to as a signal used for sensing) is transmitted and received in the following manners. The first device may be a base station or UE, and the second device may be a sensing network function device or a sensing network element of a core network, or may be a base station or UE.

Manner 1: A base station A transmits a signal used for sensing, and a base station B receives the signal used for sensing.

Manner 2: A base station transmits a signal used for sensing, and a core network device receives the signal used for sensing.

Manner 3: A base station transmits a signal used for sensing, and UE receives the signal used for sensing.

Manner 4: A core network transmits a signal used for sensing, and a base station or UE receives the signal used for sensing.

Manner 5: Abase station performs transmitting and receiving.

Manner 6: UE performs transmitting and receiving.

Manner 7: UE performs transmitting, and a base station or a core network device performs receiving.

A signal sending device in this embodiment of this application may be a plurality of devices, and a signal receiving device may be a plurality of devices. For example, the foregoing base station may be a TRP, an Access Point (AP), a relay, a Reconfigurable Intelligence Surface (RIS), or the like.

In some embodiments of this application, the sensing method may include the following steps:

Step 1: After receiving the first signal, the first device performs channel estimation, for example, performs Least Squares (LS) channel estimation or Minimum Mean Square Error (MMSE) channel estimation to obtain first channel matrices corresponding to different antenna pair combinations. Assuming that an antenna configuration uses one transmitting and four receiving, there are four antenna combinations in total, that is, there are four first channel matrices in total.

Step 2: Perform an operation on the first channel matrices based on related information of a time-frequency domain channel matrix H in first indication information sent by the second device, for example, select elements (that is, frequency domain channel responses corresponding to different subcarriers and time-domain sampling points) in the channel estimation matrix based on a time-frequency domain format of the matrix H (for example, including N time domain sampling points and M subcarriers), to obtain a second channel matrix of a dimension M*N; and calculate a quotient of second channel matrices corresponding to a first antenna transmit-receive combination and a second antenna transmit-receive combination to obtain time-frequency domain channel matrices H, where the following six H may be obtained in total:

$$H 1 = H\_tx1 \_rx1 \cdot / H\_tx1 \_rx2 ;$$

$$H 2 = H\_tx1 \_rx1 \cdot / H\_tx1 \_rx3 ;$$

$$H 3 = H\_tx1 \_rx1 \cdot / H\_tx1 \_rx4 ;$$

$$H 4 = H\_tx1 \_rx2 \cdot / H\_tx1 \_rx3 ;$$

$$H 5 = H\_tx1 \_rx2 \cdot / H\_tx1 \_rx4 ;$$

$$H 6 = H\_tx1 \_rx3 \cdot / H\_tx1 \_rx4 .$$

“./” indicates point division, that is, elements in two matrices are divided element by element, and H_tx1_rx1 indicates a second channel matrix corresponding to a transmit-receive antenna combination: a transmit antenna 1 and a receive antenna 1.

For example, a method for determining a time domain calculation window and a frequency domain calculation window of the second channel matrix or the time-frequency domain channel matrix is as follows:

Determining the time domain calculation window:

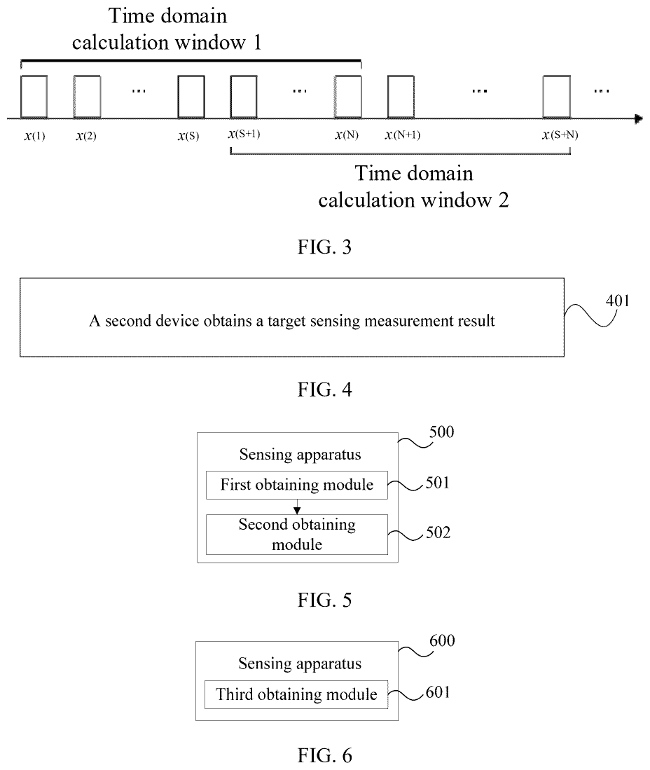

The first device receives a time domain format or a corresponding channel estimation result time domain format of the first signal. As shown in FIG. 3, a time domain sampling point interval of the first signal is associated with the sensing service requirement, for example, is associated with a moving speed of a detection target in an intrusion detection service, and meets at least: T≤1/|2·f_{d max}|, where T represents a time interval of the first signal, and f_{d max} represents maximum Doppler frequency shift caused by movement of the target. A size N of the time domain calculation window is associated with Doppler resolution. For example, if time domain calculation window duration is T, corresponding Doppler resolution is 1/T. A time domain calculation window sliding step S is associated with the sensing update frequency. The foregoing parameter may be directly indicated in the related information of the time-frequency domain channel matrix H in the first indication information sent by the second device to the first device, or may be determined by the first device based on the sensing requirement information in the first indication information sent by the second device to the first device.

Determining the frequency domain calculation window:

The first device selects sampling points corresponding to all or some subcarriers from sampling points corresponding to all subcarriers of the received first signal as the frequency domain calculation window. It is assumed that a total of M subcarriers may be consecutive or may be discontinuous, for example, selected at equal intervals.

Step 3: Perform data preprocessing on H, including at least one of the following:
noise suppression: to suppress noise in target data, where a method may be, for example, Discrete Fourier Transform (DFT), average noise suppression, MMSE filtering noise suppression, Discrete Wavelet Transformation (DWT) noise suppression, and Principal Component Analysis (PCA) noise suppression;
removing an outlier value: an outlier value in the target data is removed, and processing on the outlier value may be discarding or replacing, where a method may be, for example, a Median Absolute Deviation (MAD) algorithm or a Hampel filtering method, a standard deviation method, or a percentile method; and
filtering: smoothing filtering, for example, using Savitzky-Golay filtering, or using low-pass filtering, high-pass filtering, band-pass filtering, or band-stop filtering to remove an irrelevant frequency component.

Step 4: Obtain a frequency domain covariance matrix H_{cov} through calculation based on the time-frequency domain channel matrix H by using a frequency domain covariance matrix as an example, where a dimension is M*M, and may be represented as:

$${H}_{cov} = [ \begin{matrix}cov ( {x}_{1} , {x}_{1} ) & … & cov ( {x}_{1} , {x}_{M} ) \\ ⋮ & ⋱ & ⋮ \\ cov ( {x}_{M} , {x}_{1} ) & … & cov ( {x}_{M} , {x}_{M} )\end{matrix} ] ,$$

xₘ=[xₘ(1), xₘ(2), L, xₘ(N)] represents a vector on an m^{th} row of the time-frequency domain channel matrix, that is, N pieces of time domain sampling data corresponding to an m^{th} subcarrier; and cov represents covariance calculation

$$cov ( {x}_{a} , {x}_{b} ) = \frac{1}{N - 1} {\sum }_{n = 1}^{N} {( {x}_{a} ( n ) - {μ}_{{x}_{a}} )}^{*} ( {x}_{b} ( n ) - {μ}_{{x}_{b}} ) .$$

Step 5: Perform eigenvalue decomposition on H_{cov} to obtain M eigenvalues and arrange the M eigenvalues in descending order as λ₁, λ₂, L, λ_{M}, and further, calculate a sensing measurement result. In a case of using a ratio of eigenvalues as an example, the sensing measurement result may be:

$$\frac{{\sum }_{m = 1}^{M} {λ}_{m}}{{λ}_{1} + {λ}_{2}} - 1 ,$$

herein, a purpose of subtracting 1 is to limit a value of the result to less than 1;

$$\frac{{\sum }_{m = 1}^{M} {λ}_{m}}{{λ}_{1} + {λ}_{2}} or \frac{{λ}_{1} + {λ}_{2}}{{\sum }_{m = 1}^{M} {λ}_{m}} ;$$

$$\frac{{\sum }_{m = 1}^{M} {λ}_{m}}{{λ}_{1}} - 1 ,$$

herein, a purpose of subtracting 1 is to limit a value of the result to less than 1; and

$$\frac{{\sum }_{m = 1}^{M} {λ}_{m}}{{λ}_{1}} or \frac{{λ}_{1}}{{\sum }_{m = 1}^{M} {λ}_{m}} .$$

In this embodiment of this application, it is assumed that there are a frequency domain amplitude covariance matrix Hamp_{cov} and a frequency domain phase covariance matrix Hphase_{cov} and eigenvalue decomposition is separately performed to obtain M eigenvalues, and the M eigenvalues are represented in descending order as λamp₁, λamp₂, L, λamp_{M} and λphase₁, λphase₂, L, λphase_{M}. In this case, the sensing measurement result may be a weighted combination of an eigenvalue of an amplitude covariance matrix and an eigenvalue of a phase covariance matrix, for example:

$$α \cdot {λamp}_{1} + β \cdot {λphase}_{1} ;$$

$$α \cdot {λamp}_{2} + β \cdot {λphase}_{2} ;$$

$$α \cdot \frac{{λamp}_{1}}{{\sum }_{m = 1}^{M} {λamp}_{m}} + β \cdot \frac{{λphase}_{1}}{{\sum }_{m = 1}^{M} {λphase}_{m}} ;$$

$$α \cdot \frac{{λamp}_{2}}{{\sum }_{m = 1}^{M} {λamp}_{m}} + β \cdot \frac{{λphase}_{2}}{{\sum }_{m = 1}^{M} {λphase}_{m}} ;$$

α and β represent weighting coefficients, and meet α+β=1.

Step 6: Corresponding to a quotient of second channel matrices of different antenna combinations, obtain a plurality of sensing measurement results. For example, corresponding to H1 to H6, a total of six sensing measurement results may be obtained, and a maximum value or a minimum value is selected, or weighted combination is performed on these sensing measurement results.

Step 7: A case that a sensing measurement result is obtained through eigenvalue decomposition based on a frequency domain correlation coefficient matrix is the same as the foregoing, where a dimension of the correlation coefficient matrix H_{corr} is M*M, and the correlation coefficient matrix may be represented as:

$${H}_{corr} = [ \begin{matrix}corr ( {x}_{1} , {x}_{1} ) & … & corr ( {x}_{1} , {x}_{M} ) \\ ⋮ & ⋱ & ⋮ \\ corr ( {x}_{M} , {x}_{1} ) & … & corr ( {x}_{M} , {x}_{M} )\end{matrix} ] ,$$

where

xₘ=[xₘ(1), xₘ(2), . . . , xₘ(N)] represents a vector on an m^{th} row of the time-frequency domain channel matrix, that is, N pieces of time domain sampling data corresponding to an m^{th} subcarrier; and corr represents a correlation coefficient calculation

$$corr ( {x}_{a} , {x}_{b} ) = \frac{cov ( {x}_{a} , {x}_{b} )}{{σ}_{{x}_{a}} \cdot {σ}_{{x}_{b}}} .$$

A case that a sensing measurement result is obtained through eigenvalue decomposition based on a time domain covariance matrix and the time domain correlation coefficient matrix is the same as the foregoing, where a dimension of the time domain covariance matrix H_{cov} is N*N, and the time domain covariance matrix may be represented as:

$${H}_{cov} = [ \begin{matrix}cov ( {x}_{1} , {x}_{1} ) & … & cov ( {x}_{1} , {x}_{N} ) \\ ⋮ & ⋱ & ⋮ \\ cov ( {x}_{N} , {x}_{1} ) & … & cov ( {x}_{N} , {x}_{N} )\end{matrix} ] ,$$

where

xₙ=[xₙ(1), xₙ(2), L, xₙ(M)] represents a vector on an n^{th} column of the time-frequency domain channel matrix, that is, M pieces of subcarrier data corresponding to an n^{th} time domain sampling point.

A dimension of the time domain correlation coefficient matrix H_{corr} is N*N, and the time domain correlation coefficient matrix may be represented as:

$${H}_{corr} = [ \begin{matrix}corr ( {x}_{1} , {x}_{1} ) & … & corr ( {x}_{1} , {x}_{N} ) \\ ⋮ & ⋱ & ⋮ \\ corr ( {x}_{N} , {x}_{1} ) & … & corr ( {x}_{N} , {x}_{N} )\end{matrix} ] ,$$

where

x=[xₙ(1), xₙ(2), L, xₙ(M)] represents a vector on an n^{th} column of the time-frequency domain channel matrix, that is, M pieces of subcarrier data corresponding to an n^{th} time domain sampling point.

Step 8: Select a time domain calculation window 2 based on the sliding step in step 1 to calculate a corresponding sensing measurement result, and obtain, by analogy, sensing measurement results corresponding to different time domain calculation windows.

In this embodiment of this application, a receive end performs an operation based on a receive signal to obtain specific matrix eigenvalue-related information, and implements a wireless sensing function such as intrusion detection based on such feature information.

As shown in FIG. 4, an embodiment of this application provides a sensing method, including the following steps.

Step 401: A second device obtains a target sensing measurement result, where
the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal.

Herein, the first signal may be a sensing signal, or may be a communication signal, and the communication signal can be used for sensing. For example, the first signal may be a signal used to obtain information such as a direction, a distance, and a speed of a target object, or a signal used to detect, trace, identify, and image a target object, an event, or an environment.

The first device reports the target sensing measurement result obtained based on the at least one sensing measurement result to the second device, so that the second device can obtain information such as a location and a speed of the target object in the target environment based on the target sensing measurement result.

In this embodiment of this application, the first device performs channel estimation processing on the received first signal to obtain the at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and reports the obtained target sensing measurement result to the second device based on an eigenvalue obtained through decomposition, so that the second device can analyze the eigenvalue to obtain information such as a location and a speed of the target object in the target environment, thereby implementing a wireless sensing function in a scenario such as intrusion detection or track tracing.

In some embodiments, before the second device obtains the target sensing measurement result, the method further includes:
sending first indication information, where the first indication information is used to indicate at least one of the following:
sensing requirement information, where the sensing requirement information corresponds to at least one of a sensing measurement quantity, the first threshold information, configuration information of the first signal, and related information of the time-frequency domain channel matrix;
a sensing measurement quantity, where the sensing measurement quantity corresponds to the sensing measurement result;
the first threshold information;
configuration information of the first signal; and
related information of the time-frequency domain channel matrix.

In some embodiments, after the second device obtains the target sensing measurement result, the method further includes:
sending second indication information in a case that the target sensing measurement result meets first threshold information, where the second indication information is used to adjust a target parameter in the first indication information.

In some embodiments, the target parameter includes at least one of the following:
the sensing requirement information;
the sensing measurement quantity;
the configuration information of the first signal; and
the related information of the time-frequency domain channel matrix.

In some embodiments, the related information of the time-frequency domain matrix includes at least one of the following:
time domain calculation window information;
frequency domain calculation window information;
a sliding step of a time domain calculation window of the time-frequency domain channel matrix; and
element type indication information of the time-frequency domain channel matrix.

The foregoing second indication information and the related information of the time-frequency domain channel matrix are described in detail in the method embodiment on the first device side. Details are not described herein again.

In some embodiments, the target sensing measurement result includes at least one of the following:
a sensing measurement result that meets the first threshold information;
relationship information between the sensing measurement result and the first threshold information;
a difference between a sensing measurement result that meets the first threshold information and the first threshold information; and
target information obtained based on the time-frequency domain channel matrix, where the target information is reported in a case that the sensing measurement result meets the first threshold information; where
the target information includes at least one of the following:
Doppler information of a target object;
a speed of the target object;
coordinates of the target object;
a distance between the target object and a signal transmitting-receiving device;
an angle between the target object and the signal transmitting-receiving device; and
delay information of the first signal from being transmitted to being received.

In this embodiment of this application, the first device performs channel estimation processing on the received first signal to obtain the at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and reports the obtained target sensing measurement result to the second device based on an eigenvalue obtained through decomposition, so that the second device can analyze the eigenvalue to obtain information such as a location and a speed of the target object in the target environment, thereby implementing a wireless sensing function in a scenario such as intrusion detection or track tracing.

The sensing method provided in the embodiments of this application may be performed by a sensing apparatus. In the embodiments of this application, the sensing apparatus provided in the embodiments of this application is described by using an example in which the sensing apparatus performs the sensing method.

As shown in FIG. 5, an embodiment of this application provides a sensing apparatus 500, applied to a first device, and the apparatus includes:
a first obtaining module 501, configured to obtain at least one sensing measurement result based on an eigenvalue of at least one first matrix, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel response is obtained by a first device by performing channel estimation on a received first signal, and the first matrix is a covariance matrix or a correlation coefficient matrix corresponding to the time-frequency domain channel matrix; and
a second obtaining module 502, configured to obtain a target sensing measurement result based on the at least one sensing measurement result.

In some embodiments, the first matrix includes at least one of the following:
a frequency domain covariance matrix corresponding to the time-frequency domain channel matrix;
a frequency domain correlation coefficient matrix corresponding to the time-frequency domain channel matrix;
a time domain covariance matrix corresponding to the time-frequency domain channel matrix; and
a time domain correlation coefficient matrix corresponding to the time-frequency domain channel matrix.

In some embodiments, the first obtaining module is configured to obtain the at least one sensing measurement result based on at least one of a maximum eigenvalue, all eigenvalues, and a target eigenvalue of the first matrix, where the target eigenvalue is a largest eigenvalue among all the eigenvalues of the first matrix excluding the maximum eigenvalue.

In some embodiments, the first obtaining module is configured to obtain the at least one sensing measurement result based on a weighted combined value of the maximum eigenvalue and the target eigenvalue of the first matrix; or
obtain the at least one sensing measurement result based on a ratio between the maximum eigenvalue of the first matrix and a sum of all the eigenvalues of the first matrix; or
obtain the at least one sensing measurement result based on a ratio between a weighted combined value of the maximum eigenvalue and the target eigenvalue of the first matrix and a sum of all the eigenvalues; or
obtain the at least one sensing measurement result based on a value obtained after a preset threshold is subtracted from a ratio between a sum of all the eigenvalues of the first matrix and the maximum eigenvalue.

In some embodiments, an element in each time-frequency domain channel matrix include one of the following:
an original complex value of a frequency domain channel response corresponding to the antenna transmit-receive combination;
an amplitude of a frequency domain channel response corresponding to the antenna transmit-receive combination;
a phase of a frequency domain channel response corresponding to the antenna transmit-receive combination;
at least one of I-channel data and Q-channel data of a frequency domain channel response corresponding to the antenna transmit-receive combination;
a weighted combined value of an amplitude and a phase of a frequency domain channel response corresponding to the antenna transmit-receive combination;
a weighted combined value of I-channel data and Q-channel data of a frequency domain channel response corresponding to the antenna transmit-receive combination;
an original complex value of a first result, where the first result is a quotient or a conjugate multiplication result of frequency domain channel responses corresponding to a first antenna transmit-receive combination and a second antenna transmit-receive combination;
an amplitude of the first result;
a phase of the first result;
at least one of I-channel data and Q-channel data of the first result;
a weighted combined value of the amplitude and the phase of the first result; and
a weighted combined value of the I-channel data and the Q-channel data of the first result.

In some embodiments, the first obtaining module is configured to perform weighted combination processing on eigenvalues in at least two first matrices, to obtain the sensing measurement result.

In some embodiments, the second obtaining module is configured to use at least one sensing measurement result or a quantized value of the at least one sensing measurement result as the target sensing measurement result; or
perform weighted combination processing on at least two sensing measurement results, to obtain the target sensing measurement result.

In some embodiments, the second obtaining module is configured to perform at least one of the following:
selecting a sensing measurement result that meets first threshold information as the target sensing measurement result;
using relationship information between the sensing measurement result and the first threshold information as the target sensing measurement result;
in a case that the sensing measurement result meets the first threshold information, using a difference between the sensing measurement result and the first threshold information as the target sensing measurement result; or
in a case that the sensing measurement result meets the first threshold information, using target information obtained based on the time-frequency domain channel matrix as the target sensing measurement result; where
the target information includes at least one of the following:
Doppler information of a target object;
a speed of the target object;
coordinates of the target object;
a distance between the target object and a signal transmitting-receiving device;
an angle between the target object and the signal transmitting-receiving device; and
delay information of the first signal from being transmitted to being received.

In some embodiments, the apparatus further includes:
a reporting module, configured to report the target sensing measurement result or a quantization result of the target sensing measurement result to a second device.

In some embodiments, the target sensing measurement result further includes:
time at which the first device receives the first signal;
time at which the first device obtains the sensing measurement result or time at which the first device obtains the target sensing measurement result; and
time unit information corresponding to the first signal.

In some embodiments, the apparatus further includes:
a first receiving module, configured to receive first indication information before the first obtaining module obtains the at least one sensing measurement result based on the eigenvalue of the at least one first matrix, where the first indication information is used to indicate at least one of the following:
sensing requirement information, where the sensing requirement information corresponds to at least one of a sensing measurement quantity, the first threshold information, configuration information of the first signal, and related information of the time-frequency domain channel matrix;
a sensing measurement quantity, where the sensing measurement quantity corresponds to the sensing measurement result;
the first threshold information;
configuration information of the first signal; and
related information of the time-frequency domain channel matrix.

In some embodiments, the apparatus further includes:
a second receiving module, configured to receive second indication information after the reporting module reports the target sensing measurement result or the quantization result of the target sensing measurement result to the second device, where the second indication information is sent in a case that the target sensing measurement result meets the first threshold information, and the second indication information is used to adjust a target parameter in the first indication information.

In some embodiments, the target parameter includes at least one of the following:
the sensing requirement information;
the sensing measurement quantity;
the configuration information of the first signal; and
the related information of the time-frequency domain channel matrix.

In some embodiments, the related information of the time-frequency domain matrix includes at least one of the following:
time domain calculation window information;
frequency domain calculation window information;
a sliding step of a time domain calculation window of the time-frequency domain channel matrix; and
element type indication information of the time-frequency domain channel matrix.

In this embodiment of this application, the first device performs channel estimation processing on the received first signal to obtain the at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and obtains a target sensing measurement result based on an eigenvalue obtained through decomposition, so that information such as a location and a speed of the target object in the target environment can be obtained based on the target sensing measurement result, thereby implementing a wireless sensing function in a scenario such as intrusion detection or track tracing.

As shown in FIG. 6, an embodiment of this application further provides a sensing apparatus 600, applied to a second device, and the apparatus includes:
a third obtaining module 601, configured to obtain a target sensing measurement result; where
the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal.

In some embodiments, the apparatus in this embodiment of this application further includes:
a first sending module, configured to send first indication information before the third obtaining module obtains the target sensing measurement result, where the first indication information is used to indicate at least one of the following:
sensing requirement information, where the sensing requirement information corresponds to at least one of a sensing measurement quantity, the first threshold information, configuration information of the first signal, and related information of the time-frequency domain channel matrix;
a sensing measurement quantity, where the sensing measurement quantity corresponds to the sensing measurement result;
the first threshold information;
configuration information of the first signal; and
related information of the time-frequency domain channel matrix.

In some embodiments, the apparatus in this embodiment of this application further includes:
a second sending module, configured to: after the third obtaining module obtains the target sensing measurement result, send second indication information in a case that the target sensing measurement result meets the first threshold information, where the second indication information is used to adjust a target parameter in the first indication information.

In some embodiments, the target parameter includes at least one of the following:
the sensing requirement information;
the sensing measurement quantity;
the configuration information of the first signal; and
the related information of the time-frequency domain channel matrix.

In some embodiments, the related information of the time-frequency domain matrix includes at least one of the following:
time domain calculation window information;
frequency domain calculation window information;
a sliding step of a time domain calculation window of the time-frequency domain channel matrix; and
element type indication information of the time-frequency domain channel matrix.

In some embodiments, the target sensing measurement result includes at least one of the following:
a sensing measurement result that meets the first threshold information;
relationship information between the sensing measurement result and the first threshold information;
a difference between a sensing measurement result that meets the first threshold information and the first threshold information; and
target information obtained based on the time-frequency domain channel matrix, where the target information is reported in a case that the sensing measurement result meets the first threshold information; where
the target information includes at least one of the following:
Doppler information of a target object;
a speed of the target object;
coordinates of the target object;
a distance between the target object and a signal transmitting-receiving device;
an angle between the target object and the signal transmitting-receiving device; and
delay information of the first signal from being transmitted to being received.

In this embodiment of this application, the first device performs channel estimation processing on the received first signal to obtain the at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and reports the obtained target sensing measurement result to the second device based on an eigenvalue obtained through decomposition, so that the second device can analyze the eigenvalue to obtain information such as a location and a speed of the target object in the target environment, thereby implementing a wireless sensing function in a scenario such as intrusion detection or track tracing.

The sensing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. Another device may be a server, a Network Attached Storage (NAS), or the like. This is not specifically limited in this embodiment of this application.

The sensing apparatus provided in this embodiment of this application can implement the processes in the method embodiments in FIG. 2 and FIG. 3, and a same technical effect is achieved. To avoid repetition, details are not described herein again.

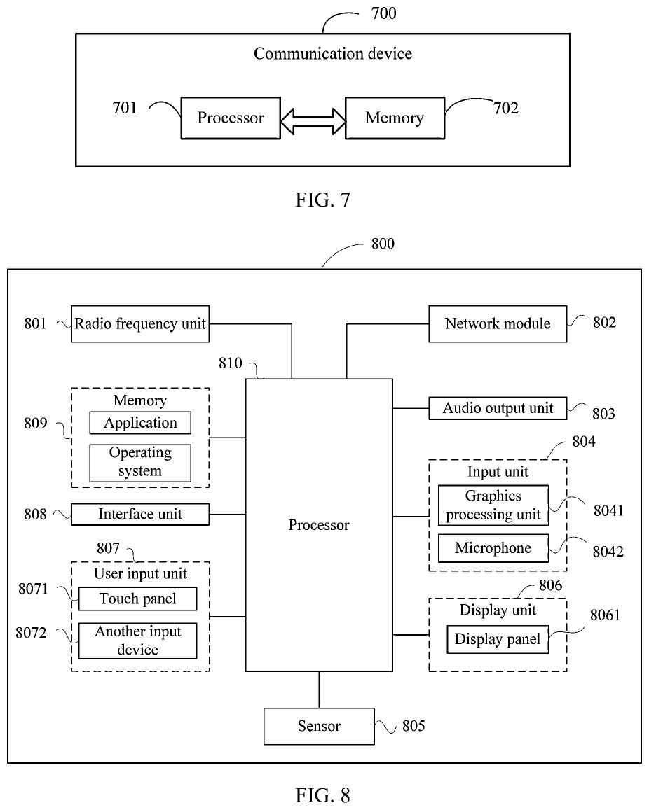

In some embodiments, as shown in FIG. 7, an embodiment of this application further provides a communication device 700, including a processor 701 and a memory 702, and the memory 702 stores a program or an instruction that can be run on the processor 701. For example, when the communications device 700 is a first device, the program or the instruction is executed by the processor 701 to implement the steps of the foregoing method embodiment on the first device side, and a same technical effect can be achieved. When the communication device 700 is a second device, the program or the instruction is executed by the processor 701 to implement the steps of the foregoing method embodiment on the second device side, and a same technical effect can be achieved. To avoid repetition, details are not described herein again.

An embodiment of this application further provides a first device, including a processor and a communication interface. The processor is configured to: obtain at least one sensing measurement result based on an eigenvalue of at least one first matrix; and obtain a target sensing measurement result based on the at least one sensing measurement result, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel responses is obtained by the first device by performing channel estimation on a received first signal, and the first matrix is a covariance matrix or a correlation matrix corresponding to the time-frequency domain channel matrix. This embodiment is corresponding to the foregoing method embodiment on the first device side. Each implementation process and implementation manner of the foregoing method embodiment may be applicable to this embodiment, and a same technical effect can be achieved.

An embodiment of this application further provides a second device, including a processor and a communication interface. The communication interface is configured to obtain a target sensing measurement result, where
the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal. This embodiment of the second device is corresponding to the foregoing method embodiment on the second device side. Each implementation process and implementation manner of the foregoing method embodiment may be applicable to this embodiment of the second device, and a same technical effect can be achieved.

For example, FIG. 8 is a schematic diagram of a hardware structure of a first device or a second device (for example, a terminal) according to an embodiment of this application.

A terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the terminal 800 may further include a power supply (such as a battery) that supplies power to each component. The power supply may be logically connected to the processor 810 by using a power supply management system, to implement functions such as charging and discharging management, and power consumption management by using the power supply management system. A terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 804 may include a Graphics Processing Unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on or off button), a trackball, a mouse, and a joystick. Details are not described herein.

In this embodiment of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, and an application or an instruction required by at least one function (for example, a sound playing function or an image playing function). In addition, the memory 809 may be a volatile memory or a non-volatile memory, or the memory 809 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static Random Access Memory (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 809 in this embodiment of this application includes but is not limited to these memories and any memory of another proper type.

The processor 810 may include one or more processing units. In some embodiments, an application processor and a modem processor may be integrated into the processor 810. The application processor mainly processes an operating system, a user interface, an application, and the like. The modem processor mainly processes a wireless communication signal, for example, a baseband processor. It may be understood that, in some embodiments, the modem processor may not be integrated into the processor 810.

In an embodiment of this application, the processor 810 is configured to: obtain at least one sensing measurement result based on an eigenvalue of at least one first matrix, where the at least one first matrix is obtained based on a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, the related information of the frequency domain channel responses is obtained by the first device by performing channel estimation on a received first signal, and the first matrix is a covariance matrix or a correlation matrix corresponding to the time-frequency domain channel matrix; and obtain a target sensing measurement result based on the at least one sensing measurement result.

In some embodiments, the first matrix includes at least one of the following:
a frequency domain covariance matrix corresponding to the time-frequency domain channel matrix;
a frequency domain correlation coefficient matrix corresponding to the time-frequency domain channel matrix;
a time domain covariance matrix corresponding to the time-frequency domain channel matrix; and
a time domain correlation coefficient matrix corresponding to the time-frequency domain channel matrix.

In some embodiments, the processor 810 is configured to obtain the at least one sensing measurement result based on at least one of a maximum eigenvalue, all eigenvalues, and a target eigenvalue of the first matrix, where the target eigenvalue is a largest eigenvalue among all the eigenvalues of the first matrix excluding the maximum eigenvalue.

In some embodiments, the processor 810 is configured to: obtain the at least one sensing measurement result based on a weighted combined value of the maximum eigenvalue and the target eigenvalue of the first matrix; or
obtain the at least one sensing measurement result based on a ratio between the maximum eigenvalue of the first matrix and a sum of all the eigenvalues of the first matrix; or
obtain the at least one sensing measurement result based on a ratio between a weighted combined value of the maximum eigenvalue and the target eigenvalue of the first matrix and a sum of all the eigenvalues; or
obtain the at least one sensing measurement result based on a value obtained after a preset threshold is subtracted from a ratio between a sum of all the eigenvalues of the first matrix and the maximum eigenvalue.

In some embodiments, an element in each time-frequency domain channel matrix include one of the following:
an original complex value of a frequency domain channel response corresponding to the antenna transmit-receive combination;
an amplitude of a frequency domain channel response corresponding to the antenna transmit-receive combination;
a phase of a frequency domain channel response corresponding to the antenna transmit-receive combination;
at least one of I-channel data and Q-channel data of a frequency domain channel response corresponding to the antenna transmit-receive combination;
a weighted combined value of an amplitude and a phase of a frequency domain channel response corresponding to the antenna transmit-receive combination;
a weighted combined value of I-channel data and Q-channel data of a frequency domain channel response corresponding to the antenna transmit-receive combination;
an original complex value of a first result, where the first result is a quotient or a conjugate multiplication result of frequency domain channel responses corresponding to a first antenna transmit-receive combination and a second antenna transmit-receive combination;
an amplitude of the first result;
a phase of the first result;
at least one of I-channel data and Q-channel data of the first result;
a weighted combined value of the amplitude and the phase of the first result; and
a weighted combined value of the I-channel data and the Q-channel data of the first result.

In some embodiments, the processor 810 is configured to perform weighted combination processing on eigenvalues in at least two first matrices, to obtain the sensing measurement result.

In some embodiments, the processor 810 is configured to: use the at least one sensing measurement result as the target sensing measurement result; or
perform weighted combination processing on at least two sensing measurement results, to obtain the target sensing measurement result.

In some embodiments, the processor 810 is configured to perform at least one of the following:
selecting a sensing measurement result that meets first threshold information as the target sensing measurement result;
using relationship information between the sensing measurement result and the first threshold information as the target sensing measurement result;
in a case that the sensing measurement result meets the first threshold information, using a difference between the sensing measurement result and the first threshold information as the target sensing measurement result; or
in a case that the sensing measurement result meets the first threshold information, using target information obtained based on the time-frequency domain channel matrix as the target sensing measurement result; where
the target information includes at least one of the following:
Doppler information of a target object;
a speed of the target object;
coordinates of the target object;
a distance between the target object and a signal transmitting-receiving device;
an angle between the target object and the signal transmitting-receiving device; and
delay information of the first signal from being transmitted to being received.

In some embodiments, the radio frequency unit 801 is configured to:
report the target sensing measurement result or a quantization result of the target sensing measurement result to a second device.

In some embodiments, the target sensing measurement result further includes:
time at which the first device receives the first signal;
time at which the first device obtains the sensing measurement result or time at which the first device obtains the target sensing measurement result; and
time unit information corresponding to the first signal.

In some embodiments, the radio frequency unit 801 is further configured to:
receive first indication information, where the first indication information is used to indicate at least one of the following:
sensing requirement information, where the sensing requirement information corresponds to at least one of a sensing measurement quantity, the first threshold information, configuration information of the first signal, and related information of the time-frequency domain channel matrix;
a sensing measurement quantity, where the sensing measurement quantity corresponds to the sensing measurement result;
the first threshold information;
configuration information of the first signal; and
related information of the time-frequency domain channel matrix.

In some embodiments, the radio frequency unit 801 is further configured to:
receive second indication information, where the second indication information is sent in a case that the target sensing measurement result meets the first threshold information, and the second indication information is used to adjust a target parameter in the first indication information.

In some embodiments, the target parameter includes at least one of the following:
the sensing requirement information;
the sensing measurement quantity;
the configuration information of the first signal; and
the related information of the time-frequency domain channel matrix.

In some embodiments, the related information of the time-frequency domain matrix includes at least one of the following:
time domain calculation window information;
frequency domain calculation window information;
a sliding step of a time domain calculation window of the time-frequency domain channel matrix; and
element type indication information of the time-frequency domain channel matrix.

In another embodiment of this application, the radio frequency unit 801 is configured to obtain a target sensing measurement result, where the target sensing measurement result is obtained by a first device based on at least one sensing measurement result, the sensing measurement result is obtained based on an eigenvalue of a first matrix, the first matrix is a covariance matrix or a correlation coefficient matrix corresponding to a time-frequency domain channel matrix, the time-frequency domain channel matrix includes related information of frequency domain channel responses corresponding to a plurality of time-frequency domain sampling points, each time-frequency domain channel matrix corresponds to one antenna transmit-receive combination, and the related information of the frequency domain channel response is obtained by the first device by performing channel estimation on a received first signal.

In some embodiments, the radio frequency unit 801 is further configured to:
send first indication information, where the first indication information is used to indicate at least one of the following:
sensing requirement information, where the sensing requirement information corresponds to at least one of a sensing measurement quantity, the first threshold information, configuration information of the first signal, and related information of the time-frequency domain channel matrix;
a sensing measurement quantity, where the sensing measurement quantity corresponds to the sensing measurement result;
the first threshold information;
configuration information of the first signal; and
related information of the time-frequency domain channel matrix.

In some embodiments, the radio frequency unit 801 is further configured to: send second indication information in a case that the target sensing measurement result meets first threshold information, where the second indication information is used to adjust a target parameter in the first indication information.

In some embodiments, the target parameter includes at least one of the following:
the sensing requirement information;
the sensing measurement quantity;
the configuration information of the first signal; and
the related information of the time-frequency domain channel matrix.

In some embodiments, the related information of the time-frequency domain matrix includes at least one of the following:
time domain calculation window information;
frequency domain calculation window information;
a sliding step of a time domain calculation window of the time-frequency domain channel matrix; and
element type indication information of the time-frequency domain channel matrix.

In some embodiments, the target sensing measurement result includes at least one of the following:
a sensing measurement result that meets the first threshold information;
relationship information between the sensing measurement result and the first threshold information;
a difference between a sensing measurement result that meets the first threshold information and the first threshold information; and
target information obtained based on the time-frequency domain channel matrix, where the target information is reported in a case that the sensing measurement result meets the first threshold information; where
the target information includes at least one of the following:
Doppler information of a target object;
a speed of the target object;
coordinates of the target object;
a distance between the target object and a signal transmitting-receiving device;
an angle between the target object and the signal transmitting-receiving device; and
delay information of the first signal from being transmitted to being received.

In this embodiment of this application, the first device performs channel estimation processing on the received first signal to obtain the at least one time-frequency domain channel matrix; obtains a covariance matrix or a correlation coefficient matrix corresponding to the time-frequency domain channel matrix; and decomposes an eigenvalue of the covariance matrix or the correlation coefficient matrix, and obtains a target sensing measurement result based on an eigenvalue obtained through decomposition, so that information such as a location and a speed of the target object in the target environment can be obtained based on the target sensing measurement result, thereby implementing a wireless sensing function in a scenario such as intrusion detection or track tracing.

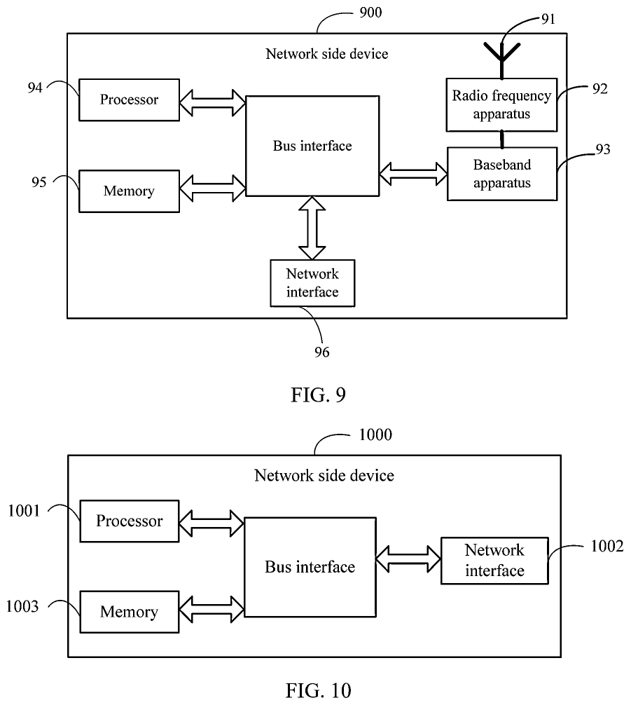

For example, an embodiment of this application further provides a network side device (which may be a first device or a second device). As shown in FIG. 9, a network side device 900 includes an antenna 91, a radio frequency apparatus 92, a baseband apparatus 93, a processor 94, and a memory 95. The antenna 91 is connected to the radio frequency apparatus 92. In an uplink direction, the radio frequency apparatus 92 receives information by using the antenna 91, and sends the received information to the baseband apparatus 93 for processing. In a downlink direction, the baseband apparatus 93 processes information that needs to be sent, and sends processed information to the radio frequency apparatus 92. The radio frequency apparatus 92 processes the received information, and sends processed information by using the antenna 91.

In the foregoing embodiment, a method performed by the first device or the second device may be implemented in the baseband apparatus 93. The baseband apparatus 93 includes a baseband processor.

For example, the baseband apparatus 93 may include at least one baseband board. A plurality of chips are disposed on the baseband board. As shown in FIG. 9, one chip is, for example, a baseband processor, and is connected to the memory 95 by using a bus interface, to invoke a program in the memory 95 to perform the operations of the network device shown in the foregoing method embodiment.

The network side device may further include a network interface 96, and the interface is, for example, a common public radio interface (common public radio interface, CPRI).

For example, the network side device 900 in this embodiment of this application further includes an instruction or a program that is stored in the memory 95 and that can be run on the processor 94, and the processor 94 invokes the instruction or program in the memory 95 to perform the method performed by the modules shown in FIG. 5 or FIG. 6, and a same technical effect is achieved. To avoid repetition, details are not described herein again.

For example, an embodiment of this application further provides a network side device (which may be a first device or a second device). As shown in FIG. 10, a network side device 1000 includes a processor 1001, a network interface 1002, and a memory 1003. The network interface 1002 is, for example, a Common Public Radio Interface (CPRI).

For example, the network side device 1000 in this embodiment of this application further includes: an instruction or a program that is stored in the memory 1003 and that can be run on the processor 1001, and the processor 1001 invokes the instruction or program in the memory 1003 to perform the method performed by the modules shown in FIG. 5 or FIG. 6, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing embodiment of the sensing method are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip, the chip includes a processor and a communication interface, the communication interface is coupled to the processor, and the processor is configured to run a program or an instruction to implement the processes of the foregoing embodiment of the sensing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program or a computer program product, the computer program or the computer program product is stored in a non-volatile storage medium, and the computer program or the computer program product is executed by at least one processor to implement the processes of the foregoing embodiment of the sensing method, and a same technical effect can be achieved. To avoid repetition, details are not described herein again.

An embodiment of this application further provides a sensing system, including a first device and a second device, where the first device may be configured to perform the steps of the sensing method on the first device side, and the second device may be configured to perform the steps of the sensing method on the second device side.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM or RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A sensing method, comprising:
obtaining, by a first device, at least one sensing measurement result based on an eigenvalue of at least one first matrix,
wherein:
the at least one first matrix is obtained based on a time-frequency domain channel matrix,
the time-frequency domain channel matrix comprises related information of frequency domain channel responses corresponding to a plurality of time-frequency domain sampling points, each time-frequency domain channel matrix corresponds to one antenna transmit-receive combination,
the related information of the frequency domain channel response is obtained by the first device by performing channel estimation on a received first signal, and
the first matrix is a covariance matrix or a correlation coefficient matrix corresponding to the time-frequency domain channel matrix; and
obtaining, by the first device, a target sensing measurement result based on the at least one sensing measurement result.

2. The sensing method according to claim 1, wherein the first matrix comprises at least one of the following:
a frequency domain covariance matrix corresponding to the time-frequency domain channel matrix;
a frequency domain correlation coefficient matrix corresponding to the time-frequency domain channel matrix;
a time domain covariance matrix corresponding to the time-frequency domain channel matrix; or
a time domain correlation coefficient matrix corresponding to the time-frequency domain channel matrix.

3. The sensing method according to claim 1, wherein the obtaining, by a first device, at least one sensing measurement result based on an eigenvalue of at least one first matrix comprises:
obtaining the at least one sensing measurement result based on at least one of a maximum eigenvalue, all eigenvalues, or a target eigenvalue of the first matrix, wherein the target eigenvalue is a largest eigenvalue among all the eigenvalues of the first matrix excluding the maximum eigenvalue;
wherein the obtaining the at least one sensing measurement result based on at least one of a maximum eigenvalue, all eigenvalues, or a target eigenvalue of the first matrix comprises:
obtaining the at least one sensing measurement result based on a weighted combined value of the maximum eigenvalue and the target eigenvalue of the first matrix; or
obtaining the at least one sensing measurement result based on a ratio between the maximum eigenvalue of the first matrix and a sum of all the eigenvalues of the first matrix; or
obtaining the at least one sensing measurement result based on a ratio between a weighted combined value of the maximum eigenvalue and the target eigenvalue of the first matrix and a sum of all the eigenvalues; or
obtaining the at least one sensing measurement result based on a value obtained after a preset threshold is subtracted from a ratio between a sum of all the eigenvalues of the first matrix and the maximum eigenvalue.

4. The sensing method according to claim 1, wherein an element in each time-frequency domain channel matrix comprises one of the following:
an original complex value of a frequency domain channel response corresponding to the antenna transmit-receive combination;
an amplitude of a frequency domain channel response corresponding to the antenna transmit-receive combination;
a phase of a frequency domain channel response corresponding to the antenna transmit-receive combination;
at least one of I-channel data and Q-channel data of a frequency domain channel response corresponding to the antenna transmit-receive combination;
a weighted combined value of an amplitude and a phase of a frequency domain channel response corresponding to the antenna transmit-receive combination;
a weighted combined value of I-channel data and Q-channel data of a frequency domain channel response corresponding to the antenna transmit-receive combination;
an original complex value of a first result, wherein the first result is a quotient or a conjugate multiplication result of frequency domain channel responses corresponding to a first antenna transmit-receive combination and a second antenna transmit-receive combination;
an amplitude of the first result;
a phase of the first result;
at least one of I-channel data or Q-channel data of the first result;
a weighted combined value of the amplitude and the phase of the first result; or
a weighted combined value of the I-channel data and the Q-channel data of the first result.

5. The sensing method according to claim 1, wherein the obtaining, by the first device, a target sensing measurement result based on the at least one sensing measurement result comprises at least one of the following:
selecting a sensing measurement result that meets first threshold information as the target sensing measurement result;
using relationship information between the sensing measurement result and the first threshold information as the target sensing measurement result;
when the sensing measurement result meets the first threshold information, using a difference between the sensing measurement result and the first threshold information as the target sensing measurement result; or
when the sensing measurement result meets the first threshold information, using target information obtained based on the time-frequency domain channel matrix as the target sensing measurement result; wherein
the target information comprises at least one of the following:
Doppler information of a target object;
a speed of the target object;
coordinates of the target object;
a distance between the target object and a signal transmitting-receiving device;
an angle between the target object and the signal transmitting-receiving device; or
delay information of the first signal from being transmitted to being received.

6. The sensing method according to claim 1, further comprising:
reporting, by the first device, the target sensing measurement result or a quantization result of the target sensing measurement result to a second device.

7. The sensing method according to claim 6, before the obtaining, by a first device, at least one sensing measurement result based on an eigenvalue of at least one first matrix, further comprising:
receiving first indication information, wherein the first indication information is used to indicate at least one of the following:
sensing requirement information, wherein the sensing requirement information corresponds to at least one of a sensing measurement quantity, first threshold information, configuration information of the first signal, or related information of the time-frequency domain channel matrix;
a sensing measurement quantity, wherein the sensing measurement quantity corresponds to the sensing measurement result;
the first threshold information;
configuration information of the first signal; or
related information of the time-frequency domain channel matrix;
wherein the related information of the time-frequency domain channel matrix comprises at least one of the following:
time domain calculation window information;
frequency domain calculation window information;
a sliding step of a time domain calculation window of the time-frequency domain channel matrix; or
element type indication information of the time-frequency domain channel matrix.

8. The sensing method according to claim 7, after the reporting, by the first device, the target sensing measurement result or a quantization result of the target sensing measurement result to a second device, further comprising:
receiving second indication information, wherein the second indication information is sent when the target sensing measurement result meets the first threshold information, and the second indication information is used to adjust a target parameter in the first indication information.

9. The sensing method according to claim 8, wherein the target parameter comprises at least one of the following:
the sensing requirement information;
the sensing measurement quantity;
the configuration information of the first signal; or
the related information of the time-frequency domain channel matrix.

10. A sensing method, comprising:
obtaining, by a second device, a target sensing measurement result,
wherein:
the target sensing measurement result is obtained by a first device based on at least one sensing measurement result,
the sensing measurement result is obtained based on an eigenvalue of a first matrix,
the first matrix is a covariance matrix or a correlation coefficient matrix corresponding to a time-frequency domain channel matrix,
the time-frequency domain channel matrix comprises related information of frequency domain channel responses corresponding to a plurality of time-frequency domain sampling points,
each time-frequency domain channel matrix corresponds to one antenna transmit-receive combination, and
the related information of the frequency domain channel response is obtained by the first device by performing channel estimation on a received first signal.

11. The sensing method according to claim 10, before the obtaining, by a second device, a target sensing measurement result, further comprising:
sending first indication information, wherein the first indication information is used to indicate at least one of the following:
sensing requirement information, wherein the sensing requirement information corresponds to at least one of a sensing measurement quantity, first threshold information, configuration information of the first signal, and related information of the time-frequency domain channel matrix;
a sensing measurement quantity, wherein the sensing measurement quantity corresponds to the sensing measurement result;
the first threshold information;
configuration information of the first signal; and
related information of the time-frequency domain channel matrix;
wherein the related information of the time-frequency domain channel matrix comprises at least one of the following:
time domain calculation window information;
frequency domain calculation window information;
a sliding step of a time domain calculation window of the time-frequency domain channel matrix; or
element type indication information of the time-frequency domain channel matrix.

12. The sensing method according to claim 11, wherein after the obtaining, by a second device, a target sensing measurement result, the method further comprises:
sending second indication information when the target sensing measurement result meets first threshold information, wherein the second indication information is used to adjust a target parameter in the first indication information.

13. The sensing method according to claim 12, wherein the target parameter comprises at least one of the following:
the sensing requirement information;
the sensing measurement quantity;
the configuration information of the first signal; or
the related information of the time-frequency domain channel matrix.

14. The sensing method according to claim 10, wherein the target sensing measurement result comprises at least one of the following:
a sensing measurement result that meets the first threshold information;
relationship information between the sensing measurement result and the first threshold information;
a difference between a sensing measurement result that meets the first threshold information and the first threshold information; and
target information obtained based on the time-frequency domain channel matrix, wherein the target information is reported when the sensing measurement result meets the first threshold information; wherein
the target information comprises at least one of the following:
Doppler information of a target object;
a speed of the target object;
coordinates of the target object;
a distance between the target object and a signal transmitting-receiving device;
an angle between the target object and the signal transmitting-receiving device; or
delay information of the first signal from being transmitted to being received.

15. A communication device, comprising a processor and a memory storing a computer program or an instruction that is capable of running on the processor, wherein the program or the instruction, when executed by the processor, causes the electronic device to perform:
obtaining, by a first device, at least one sensing measurement result based on an eigenvalue of at least one first matrix,
wherein:
the at least one first matrix is obtained based on a time-frequency domain channel matrix,
the time-frequency domain channel matrix comprises related information of frequency domain channel responses corresponding to a plurality of time-frequency domain sampling points, each time-frequency domain channel matrix corresponds to one antenna transmit-receive combination,
the related information of the frequency domain channel response is obtained by the first device by performing channel estimation on a received first signal, and
the first matrix is a covariance matrix or a correlation coefficient matrix corresponding to the time-frequency domain channel matrix; and
obtaining, by the first device, a target sensing measurement result based on the at least one sensing measurement result.

16. The communication device of claim 15, wherein the first matrix comprises at least one of the following:
a frequency domain covariance matrix corresponding to the time-frequency domain channel matrix;
a frequency domain correlation coefficient matrix corresponding to the time-frequency domain channel matrix;
a time domain covariance matrix corresponding to the time-frequency domain channel matrix; or
a time domain correlation coefficient matrix corresponding to the time-frequency domain channel matrix.

17. The communication device of claim 15, wherein the obtaining, by a first device, at least one sensing measurement result based on an eigenvalue of at least one first matrix comprises:
obtaining the at least one sensing measurement result based on at least one of a maximum eigenvalue, all eigenvalues, or a target eigenvalue of the first matrix, wherein the target eigenvalue is a largest eigenvalue among all the eigenvalues of the first matrix excluding the maximum eigenvalue;
wherein the obtaining the at least one sensing measurement result based on at least one of a maximum eigenvalue, all eigenvalues, or a target eigenvalue of the first matrix comprises:
obtaining the at least one sensing measurement result based on a weighted combined value of the maximum eigenvalue and the target eigenvalue of the first matrix; or
obtaining the at least one sensing measurement result based on a ratio between the maximum eigenvalue of the first matrix and a sum of all the eigenvalues of the first matrix; or
obtaining the at least one sensing measurement result based on a ratio between a weighted combined value of the maximum eigenvalue and the target eigenvalue of the first matrix and a sum of all the eigenvalues; or
obtaining the at least one sensing measurement result based on a value obtained after a preset threshold is subtracted from a ratio between a sum of all the eigenvalues of the first matrix and the maximum eigenvalue.

18. The communication device of claim 15, wherein an element in each time-frequency domain channel matrix comprises one of the following:
an original complex value of a frequency domain channel response corresponding to the antenna transmit-receive combination;
an amplitude of a frequency domain channel response corresponding to the antenna transmit-receive combination;
a phase of a frequency domain channel response corresponding to the antenna transmit-receive combination;
at least one of I-channel data and Q-channel data of a frequency domain channel response corresponding to the antenna transmit-receive combination;
a weighted combined value of an amplitude and a phase of a frequency domain channel response corresponding to the antenna transmit-receive combination;
a weighted combined value of I-channel data and Q-channel data of a frequency domain channel response corresponding to the antenna transmit-receive combination;
an original complex value of a first result, wherein the first result is a quotient or a conjugate multiplication result of frequency domain channel responses corresponding to a first antenna transmit-receive combination and a second antenna transmit-receive combination;
an amplitude of the first result;
a phase of the first result;
at least one of I-channel data or Q-channel data of the first result;
a weighted combined value of the amplitude and the phase of the first result; or
a weighted combined value of the I-channel data and the Q-channel data of the first result.

19. The communication device of claim 15, wherein the obtaining, by the first device, a target sensing measurement result based on the at least one sensing measurement result comprises at least one of the following:
selecting a sensing measurement result that meets first threshold information as the target sensing measurement result;
using relationship information between the sensing measurement result and the first threshold information as the target sensing measurement result;
when the sensing measurement result meets the first threshold information, using a difference between the sensing measurement result and the first threshold information as the target sensing measurement result; or
when the sensing measurement result meets the first threshold information, using target information obtained based on the time-frequency domain channel matrix as the target sensing measurement result; wherein
the target information comprises at least one of the following:
Doppler information of a target object;
a speed of the target object;
coordinates of the target object;
a distance between the target object and a signal transmitting-receiving device;
an angle between the target object and the signal transmitting-receiving device; or
delay information of the first signal from being transmitted to being received.

20. A communication device, comprising a processor and a memory storing a computer program or an instruction that is capable of running on the processor, wherein the program or the instruction, when executed by the processor, causes the electronic device to perform the steps of the sensing method according to claim 10.
